(19) United States
(12) Patent Application Publication
(10) Pub. No.: US 2024/0107941 A1
(43) Pub. Date: Apr. 4, 2024

(54) ELECTRIC WORKING MACHINE, INFORMATION PROCESSING DEVICE, AND STORAGE MEDIUM STORING CONTROL PROGRAM

(71) Applicant: HONDA MOTOR CO., LTD., Tokyo (JP)

(72) Inventor: Haruka HIYOSHI, Tokyo (JP)

(73) Assignee: HONDA MOTOR CO., LTD., Tokyo (JP)

(21) Appl. No.: 17/956,177

(22) Filed: Sep. 29, 2022

(51) Int. Cl. A01D 34/78; A01D 34/82

(52) U.S. Cl. CPC A01D 34/78; A01D 34/828; A01D 2101/00

(57) ABSTRACT

There is provided an electric working machine including a motor, a working unit configured to be driven by the motor to perform work, and a control unit configured to cause a pseudo engine sound to be output from an output unit. There is also provided an information processing device used for an electric working machine configured to be driven by a motor to perform work. The information processing device includes a communication unit configured to communicate with the electric working machine, a working status obtaining unit configured to obtain a working status of the electric working machine via the communication unit, and a control unit configured to cause a pseudo engine sound to be output from an output unit according to the obtained working status of the electric working machine.

### TECHNICAL FIELD

The present disclosure relates to an electric working machine, information processing device and a storage medium storing a control program.

### BACKGROUND

In place of a conventional engine working machine using an engine as a driving source, there is provided an electric working machine using a motor as a driving source, such as an electric lawn mower, an electric cultivator, an electric snow removal machine and the like.

An electric working machine using a motor as a driving source has a lower noise level than an engine working machine using an engine as a driving source. JP2003-061435A discloses an electric working machine provided with a buzzer which sounds while the electric working machine is working so as to inform the operator that the electric working machine is working.

### SUMMARY

An engine working machine provides the operator with an effect of causing the operator to concentrate or focusing on the work through an engine sound and/or a vibration during working.

The present disclosure provides an electric working machine, an information processing device, and a storage medium storing a control program which provide an effect of causing an operator to concentrate or focus on work.

According to an aspect of the present disclosure, there is provided an electric working machine including:
a motor;
a working unit configured to be driven by the motor to perform work; and
a control unit configured to cause a pseudo engine sound to be output from an output unit.

According to another aspect of the present disclosure, there is provided an information processing device used for an electric working machine configured to be driven by a motor to perform work, the information processing device including:
a communication unit configured to communicate with the electric working machine; a working status obtaining unit configured to obtain a working status of the electric working machine via the communication unit; and a control unit configured to cause a pseudo engine sound to be output from an output unit according to the obtained working status of the electric working machine.

According to a further aspect of the present disclosure, there is provided a non-transitory storage medium storing a control program of an information processing device used for an electric working machine configured to be driven by a motor to perform work, the control program, when executed by a processor of the information processing device, causing the information processing device to operate as:
a working status obtaining unit configured to obtain a working status of the electric working machine; and a control unit configured to cause a pseudo engine sound to be output from an output unit according to the obtained working status of the electric working machine.

According to the above-described electric working machine, information processing device, or storage medium storing the control program, an effect can be provided which causes the operator to more easily concentrate or focus on the work through a pseudo engine sound or a working sound.

### BRIEF DESCRIPTION OF DRAWINGS

FIG. 1 is a perspective view of an electric lawn mower according to a first embodiment of the present disclosure.

FIG. 2 is a side view of the electric lawn mower shown in FIG. 1.

FIG. 3 is a block diagram showing a functional configuration of the electric lawn mower shown in FIG. 1.

FIG. 4 is a block diagram showing a functional configuration of an electric lawn mower and a smartphone according to a second embodiment of the present disclosure.

### DESCRIPTION OF EMBODIMENTS

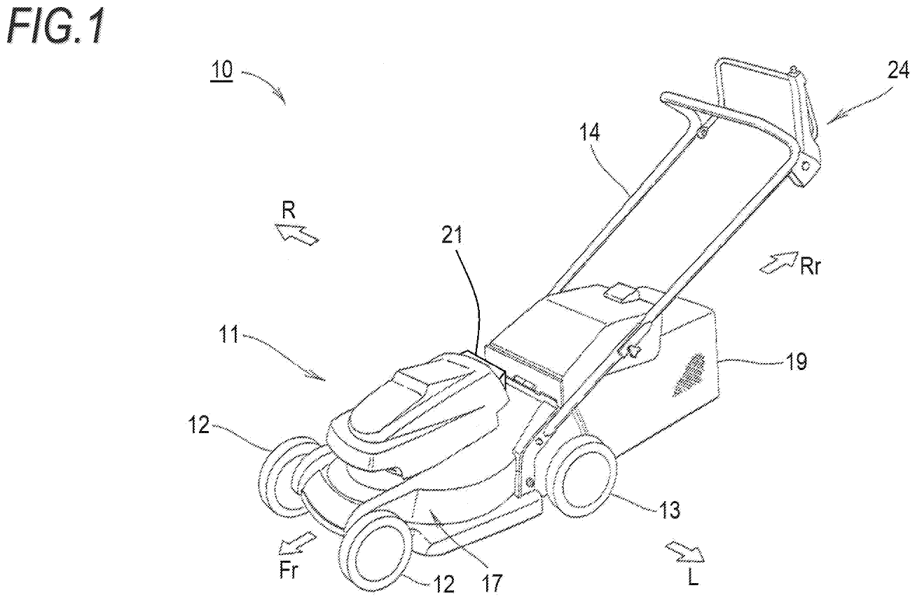

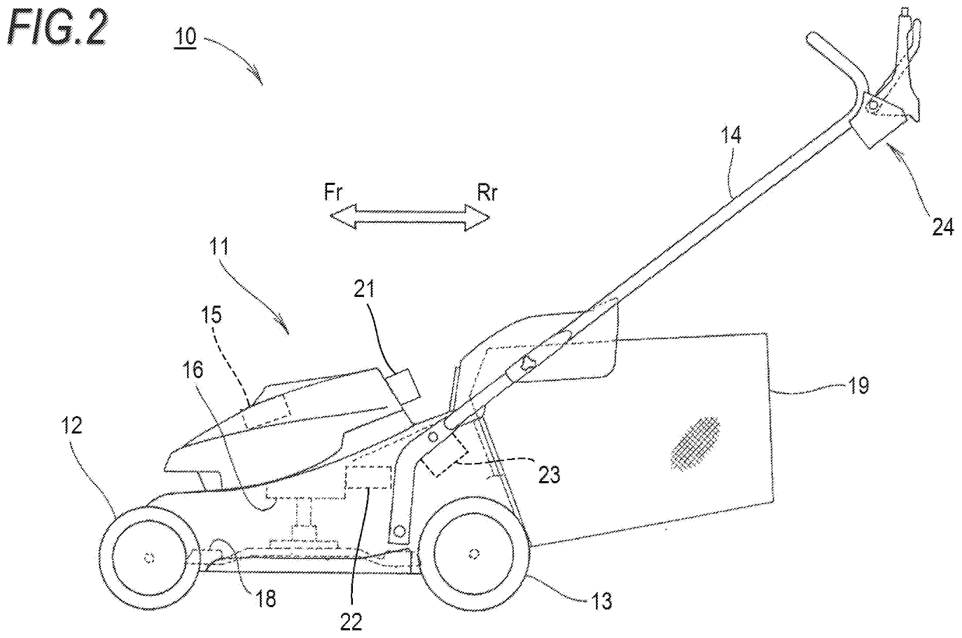

Embodiments of the present disclosure will be described with reference to the accompanying drawings. It is noted that the drawings are to be seen in the direction of the reference numerals. Each of the front, rear, left, right, upper and lower directions will be described as a direction as seen from an operator of an electric lawn mower 10 shown in FIGS. 1 and 2. In the drawings, Fr denotes a front side, Rr denotes a rear side, L denotes a left side, and R denotes a right side. In the present embodiments, an electric lawn mower which is driven by a motor is described as an example of an electric working machine. The electric working machine may be a cultivator, a snow removal machine, construction machine or the like which is driven by a motor.

### First Embodiment

FIG. 1 is a perspective view of an electric lawn mower 10 according to a first embodiment of the present disclosure. FIG. 2 is a side view of the electric lawn mower 10 shown in FIG. 1.

The electric lawn mower 10 includes a machine body 11, a front wheel 12, a rear wheel 13, a handle 14, a battery 15, a motor 16, a cutter housing 17, a cutter blade 18, a grass bag 19, a speaker (an example of an output unit) 21, a sensor 22 and a vibration generator 23.

The machine body 11 is supported by the front wheel 12 and the rear wheel 13. The handle 14 is provided on the rear side of the machine body 11 so as to extend obliquely upward and rearward. The operator of the electric lawn mower 10 holds the handle 14 and moves the electric lawn mower 10 in the front-rear direction to perform work.

The battery 15 is detachably attached to an upper portion of the machine body 11. The motor 16 is provided at a center portion of the machine body 11 and is driven by power supply of the battery 15. The cutter housing 17 is provided at a lower portion of the machine body 11. The cutter blade 18 is provided inside the cutter housing 17. The grass bag 19 is detachably attached to the rear side of the machine body 11. The motor 16 drives and rotates the cutter blade 18 to cut grass. The grass cut by the cutter blade 18 is collected by the grass bag 19.

The handle 14 is provided with an operation part 24 for operating the electric lawn mower 10. The operator operates the operation part 24 to turn on/off the motor 16 to perform work.

The speaker 21 is provided at an upper portion of the machine body 11. The speaker 21 may be detachably attached to the machine body 11. The speaker 21 may output a sound having directivity and may be attached to the electric lawn mower 10 such that the output sound is directed to the operator of the electric lawn mower 10.

The sensor 22 is provided to the machine body 11. The sensor 22 detects a traveling speed of the electric lawn mower 10, a rotation speed or a load of the cutter blade 18, and a rotation speed or a current value of the motor 16. The machine body 11 may be provided with a traveling motor which assists the traveling of the electric lawn mower 10. In this case, the sensor 22 may further detect a rotation speed or a current value of the traveling motor.

The vibration generator 23 is provided to the machine body 11. The vibration generator 23 generates a vibration in the electric lawn mower 10. The vibration generator 23 may have any structure as long as a vibration can be generated in the electric lawn mower 10. For example, the vibration generator 23 may have a structure where a weight is provided to the rotation shaft of a motor while the center of gravity of the weight is biased, and a vibration may be generated by the motor rotating the rotation shaft with the weight. The vibration generator 23 may be provided at any position of the machine body 11 or the handle 14 as long as the vibration is transmitted to the operator via the handle 14.

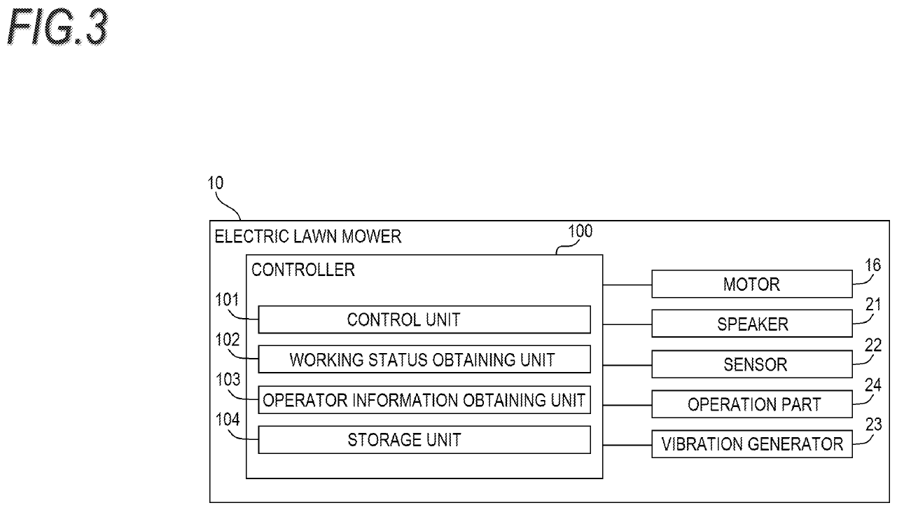

FIG. 3 is a block diagram showing a functional configuration of the electric lawn mower 10. The electric lawn mower 10 includes a controller 100 which controls the entire electric lawn mower 10. The controller 100 includes a control unit 101, a working status obtaining unit 102, an operator information obtaining unit 103 and a storage unit 104.

Each function of the controller 100 is realized by, for example, a hardware processor such as a Central Processing Unit (CPU) executing a program (software). The program may be downloaded from a server and installed in the controller. Some or all of the functional units may be realized by hardware (including circuitry) such as Large Scale Integration (LSI), Application Specific Integrated Circuit (ASIC), Field-Programmable Gate Array (FPGA), Graphics Processing Unit (GPU), or the like, or may be realized by cooperation of software and hardware. The program may be stored in advance in a storage device such as an HDD or a flash memory of the controller 100.

The control unit 101 controls on/off and the rotation speed of the motor 16 in response to the operation of the operator on the operation part 24. The working status obtaining unit 102 obtains the working status of the electric lawn mower 10 from the sensor 22. The working status includes, for example, a traveling speed of the electric lawn mower 10, a rotation speed or a current value of the traveling motor, a rotation speed or a load of the cutter blade 18, and a rotation speed or a current value of the motor 16. The operator information obtaining unit 103 obtains body information such as a heart rate or a pulse of the operator. The operator information obtaining unit 103 may obtain the body information detected by a biological sensor which is provided on the handle 14 of the electric lawn mower 10. Alternatively, the operator information obtaining unit 103 may obtain the body information of the operator detected by a detector worn by the operator through wired or wireless communication.

The control unit 101 controls the speaker 21 to output a pseudo engine sound. The pseudo engine sound is generated based on sound data stored in the storage unit 104 and is output from the speaker 21. The pseudo engine sound is a sound which artificially reproduces an engine sound to be generated by a lawn mower (working machine) using an engine as a driving source. The pseudo engine sound may be a sound including an engine sound added or mixed with other sounds such as a vibration sound of the housing and a rain sound. The output pseudo engine sound can raise the mood of the operator and cause the operator to concentrate or focus on the work.

The control unit 101 may adjust the pseudo engine sound according to the working status of the electric lawn mower 10 obtained by the working status obtaining unit 102. The control unit 101 may adjust, for example, at least one of the volume, speed, and pitch of the pseudo engine sound. The working status may include, for example, a traveling speed of the electric lawn mower 10, a rotation speed or a current value of the traveling motor, a rotation speed or a load of the cutter blade 18, a rotation speed or a current value of the motor 16. The pseudo engine sound may be adjusted by, for example, an operator operating the operation part 24.

For example, when the traveling speed of the electric lawn mower 10 is high, the control unit 101 may increase the speed of the pseudo engine sound. When the rotation speed of the cutter blade 18 is high, the control unit 101 may increase the volume of the pseudo engine sound and also increase the pitch thereof. Accordingly, the reproducibility of a sound to be generated by a lawn mower using an actual engine as the driving source may be enhanced. Further, the working status can be fed back to the operator, which can provide a comfortable sense on the work to the operator.

The storage unit 104 stores a plurality of different types of the pseudo engine sound, and the control unit 101 may selectively output the plurality of different types of the pseudo engine sound from the speaker 21. An engine sound to be generated by an engine lawn mower having an engine as a driving source is different depending on a machine body on which the engine is mounted, and an engine sound may include an engine sound to be generated by an engine mounted on a resin machine body and an engine sound to be generated by an engine mounted on a steel machine body. The control unit 101 may selectively output the plurality of types of the pseudo engine sound which artificially reproduces the plurality of different engine sounds from the speaker 21. The types of the pseudo engine sound to be output may be selected by the operator through, for example, the operation part 24.

The control unit 101 may control the vibration generator 23 to generate a vibration in conjunction with the volume of the pseudo engine sound output from the speaker 21. In a lawn mower having an engine as the driving source, for example, when the load of a cutter blade 18 increases, the sound of the engine increases and also the vibration increases. On the other hand, in a lawn mower having a motor as the driving source, the sound and the vibration of the motor do not so increase even when the load of the cutter blade 18 increases. Accordingly, when the volume of the pseudo engine sound is increased according to the load of the cutter blade 18, the vibration is generated from the vibration generator 23 in conjunction with the pseudo engine sound. Thereby, the discomfort of the operator caused by the change of the driving source from the engine to the motor can be reduced.

The control unit 101 may adjust the pseudo engine sound output from the speaker 21 according to the heart rate or the pulse of the operator obtained by the operator information obtaining unit 103. For example, when the heart rate of the operator is high, the mood of the operator may be enhanced by increasing the pitch of the pseudo engine sound or the mood of the operator may be calmed down by decreasing the pitch.

In the above-described embodiment, the control unit 101 outputs the pseudo engine sound using the speaker 21 as an output unit. However, the pseudo engine sound may be output from a smartphone (an example of a terminal device) held by the operator or an earphone (an example of an output device) worn by the operator. In this case, the control unit 101 may be configured to perform wireless or wired communication with the smartphone or the earphone and may communicate with and control the smartphone or the earphone to output the pseudo engine sound.

### Second Embodiment

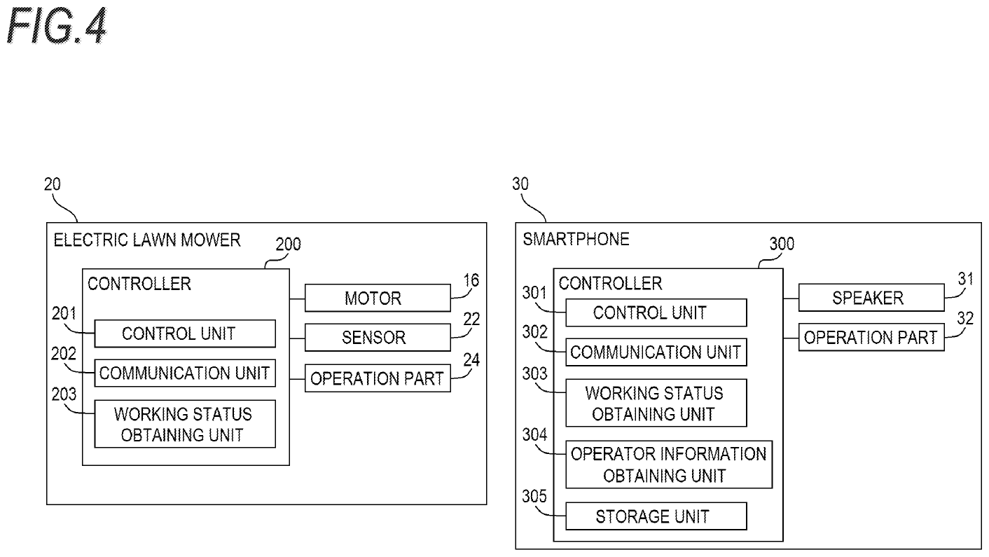

FIG. 4 is a block diagram showing a functional configuration of an electric lawn mower 20 and a smartphone 30 according to a second embodiment of the present disclosure. For the electric lawn mower 20, similar components to those of the first embodiment are denoted by the same reference numerals, and the description thereof is omitted. The smartphone 30 is an example of an information processing device. The information processing device may be a smartwatch or other information processing devices.

The electric lawn mower 20 according to the second embodiment includes a controller 200. The controller 200 includes a control unit 201, a communication unit 202 and a working status obtaining unit 203.

Each function of the controller 200 is realized by, for example, a hardware processor such as a CPU executing a program. The program may be downloaded from a server and installed in the controller. Some or all of the functional units may be realized by hardware such as LSI, ASIC, FPG, GPU or the like, or may be realized by cooperation of software and hardware. The program may be stored in advance in a storage device such as an HDD or a flash memory of the controller 200.

The control unit 201 controls on/off and the rotation speed of the motor 16 in response to the operation of the operator on the operation part 24. The communication unit 202 is communicably connected to a communication unit 302 of the smartphone 30. The working status obtaining unit 203 obtains the working status of the electric lawn mower 20 from the sensor 22. The working status may include, for example, a traveling speed of the electric lawn mower 20, a rotation speed or a current value of the traveling motor, a rotation speed or a load of the cutter blade 18, a rotation speed or a current value of the motor 16.

The smartphone 30 includes a speaker 31, an operation part 32 and a controller 300. The speaker 31 outputs a sound. The operation part 32 receives an operation of the operator. The controller 300 includes a control unit 301, a communication unit 302, a working status obtaining unit 303, an operator information obtaining unit 304 and a storage unit 305.

Each function of the controller 300 is realized by, for example, a hardware processor such as a CPU executing a program. The program may be downloaded from a server and installed in the controller. Some or all of the functional units may be realized by hardware such as LSI, ASIC, FPG, GPU or the like, or may be realized by cooperation of software and hardware. The program may be stored in advance in a storage device such as an HDD or a flash memory of the controller 300.

The control unit 301 controls the smartphone 30. The communication unit 302 is communicably connected to the communication unit 202 of the electric lawn mower 20. The communication unit 302 may communicate with an output device such as an earphone worn by the operator. The working status obtaining unit 303 obtains the working status of the electric lawn mower 20 via communication by the communication unit 302. The working status may include, for example, a traveling speed of the electric lawn mower 20, a rotation speed or a current value of the traveling motor, a rotation speed or a load of the cutter blade 18, a rotation speed or a current value of the motor 16. The operator information obtaining unit 304 obtains body information such as a heart rate or a pulse of the operator. The operator information obtaining unit 304 may obtain the body information of the operator detected by a detector worn by the operator through wired or wireless communication. The storage unit 305 stores data.

The control unit 301 controls the speaker 31 to output a pseudo engine sound. The pseudo engine sound is generated based on sound data stored in advance in the storage unit 305 and is output from the speaker 31. The pseudo engine sound is a sound which artificially reproduces an engine sound to be generated by a lawn mower (working machine) using an engine as a driving source. The control unit 301 may cause a pseudo engine sound to be output from an output device such as an earphone worn by the operator, via the communication unit 302. The output pseudo engine sound can raise the mood of the operator and cause the operator to concentrate or focus on the work.

The control unit 301 may adjust the pseudo engine sound according to the working status of the electric lawn mower 20 obtained by the working status obtaining unit 303. The control unit 301 may adjust, for example, at least one of the volume, speed, and pitch of the pseudo engine sound. The working status may include, for example, a traveling speed of the electric lawn mower 20, a rotation speed or a current value of the traveling motor, a rotation speed or a load of the cutter blade 18, a rotation speed or a current value of the motor 16. The pseudo engine sound may be adjusted by, for example, an operator operating the operation part 32.

For example, when the traveling speed of the electric lawn mower 20 is high, the control unit 301 may increase the speed of the pseudo engine sound. When the rotation speed of the cutter blade 18 is high, the control unit 301 may increase the volume of the pseudo engine sound and also increase the pitch thereof. Accordingly, the reproducibility of a sound to be generated by a lawn mower using an actual engine as the driving source may be enhanced. Further, the working status can be fed back to the operator, which can provide a comfortable sense on the work to the operator.

The storage unit 305 stores a plurality of different types of the pseudo engine sound, and the control unit 301 may selectively output the plurality of different types of the pseudo engine sound from the speaker 31. An engine sound is different depending on a machine body on which the engine is mounted, and an engine sound may include an engine sound to be generated by an engine mounted on a resin machine body and an engine sound to be generated by an engine mounted on a steel machine body. The control unit 301 may selectively output the plurality of types of the pseudo engine sound which artificially reproduces the plurality of different engine sounds from the speaker 31. The type of the pseudo engine sound to be output may be selected by the operator through, for example, the operation part 32.

The control unit 301 may adjust the pseudo engine sound output from the speaker 31 according to the heart rate or the pulse of the operator obtained by the operator information obtaining unit 304. For example, when the heart rate of the operator is high, the mood of the operator may be enhanced by increasing the pitch of the pseudo engine sound or the mood of the operator may be calmed down by decreasing the pitch.

The present disclosure discloses at least the following contents. In the parentheses, the corresponding components and the like in the above embodiments are described, but the present invention is not limited thereto.

(1) An electric working machine (electric lawn mower 10) includes.
a motor (motor 16);
a working unit (cutter blade 18) configured to be driven by the motor to perform work; and
a control unit (control unit 101) configured to cause a pseudo engine sound to be output from an output unit (speaker 21).

According to the configuration of (1), the electric working machine driven by the motor outputs the pseudo engine sound, thereby providing an effect of causing the operator to concentrate or focus on the work.

(2) In the electric working machine of (1),

the control unit may be configured to adjust the pseudo engine sound to be output from the output unit according to a working status of the electric working machine.

According to the configuration of (2), the reproducibility of a sound to be generated by an engine working machine can be enhanced, thereby enhancing an effect of causing the operator to concentrate or focus on the work.

(3) In the electric working machine of (2),

the control unit may be configured to adjust the pseudo engine sound to be output from the output unit according to at least any one of (i) a traveling speed of the electric working machine, (ii) a rotation speed of a traveling motor, (iii) a current value of the traveling motor, (iv) a rotation speed of the working unit, (v) a load of the working unit, (vi) a rotation speed of the motor and (vii) a current value of the motor.

According to the configuration of (3), the reproducibility of a sound to be generated by an engine working machine can be enhanced, thereby further enhancing an effect of causing the operator to concentrate or focus on the work.

(4) In the electric working machine of (3),
the working unit may include a cutter blade (cutter blade 18) configured to be driven by the motor to cut grass, and
the control unit may be configured to adjust the pseudo engine sound to be output from the output unit according to a rotation speed of the cutter blade or a load of the cutter blade.

According to the configuration of (4), a white noise is generated by mixture of a grass cutting sound by the cutter blade and the pseudo engine sound, thereby further enhancing an effect of causing the operator to concentrate or focus on the work.

(5) In the electric working machine of (1),

the control unit may be configured to cause a plurality of different types of the pseudo engine sound to be selectively output from the output unit.

According to the configuration of (5), the pseudo engine sound which allows the operator to further concentrate or focus on the work can be selected, thereby further enhancing an effect of causing the operator to concentrate or focus on the work.

(6) The electric working machine of (1) may further include:

a vibration generator configured to generate a vibration in the electric working machine.

According to the configuration of (6), a vibration to be generated by an engine working machine can be provided to the electric working machine, thereby enhancing an effect of causing the operator to concentrate or focus on the work.

(7) In the electric working machine of (6), the control unit may be configured to control the vibration generator to generate a vibration in conjunction with a volume of the pseudo engine sound output form the output unit.

According to the configuration of (7), a vibration is generated in conjunction with the volume of the pseudo engine sound, thereby enhancing an effect of causing the operator to concentrate or focus on the work.

(8) The electric working machine of (1) may further include:
an operator information obtaining unit configured to obtain a heart rate or a pulse of an operator of the electric working machine, and
the control unit may be configured to adjust the pseudo engine sound according to the obtained heart rate or pulse.

According to the configuration of (8), the pseudo engine sound is adjusted according to the heart rate or pulse of the operator, thereby enhancing an effect of causing the operator to concentrate or focus on the work.

(9) The electric working machine of (1),

the output unit may include a speaker provided to the electric working machine such that an output sound is directed to an operator of the electric working machine.

According to the configuration of (9), the pseudo engine sound is output to be directed to the operator, thereby enhancing an effect of causing the operator to concentrate or focus on the work while keeping noise level low to surroundings of the operator.

(10) The electric working machine of (1),
the output unit may include a terminal device which is detachably attached to the electric working machine or is held by an operator of the electric working machine, or an output device worn by an operator of the electric working machine, and
the terminal device or the output device may be configured to communicate with the control unit.

According to the configuration of (10), the output unit can be attached later. Further, the pseudo engine sound can be output not from the electric working machine but from the terminal device held by the operator or the output device worn by the operator. Therefore, it is not necessary to provide the output unit to the electric working machine.

(11) An information processing device used for an electric working machine configured to be driven by a motor to perform work includes:
a communication unit configured to communicate with the electric working machine;
a working status obtaining unit configured to obtain a working status of the electric working machine via the communication unit; and
a control unit configured to cause a pseudo engine sound to be output from an output unit according to the obtained working status of the electric working machine.

According to the configuration of (11), the information processing device used for the electric working machine driven by the motor outputs the pseudo engine sound, thereby providing an effect of causing the operator to concentrate or focus on the work.

(12) A non-transitory storage medium stores a control program of an information processing device used for an electric working machine configured to be driven by a motor to perform work, the control program, when executed by a processor of the information processing device, causing the information processing device to operate as:
a working status obtaining unit configured to obtain a working status of the electric working machine; and
a control unit configured to cause a pseudo engine sound to be output from an output unit according to the obtained working status of the electric working machine.

According to the configuration of (12), the control program of the information processing device used for the electric working machine driven by the motor outputs the pseudo engine sound, thereby providing an effect of causing the operator to concentrate or focus on the work.

1. An electric working machine comprising:
a motor;
a working unit configured to be driven by the motor to perform work; and
a control unit configured to cause a pseudo engine sound to be output from an output unit.

2. The electric working machine according to claim 1,
wherein the control unit is configured to adjust the pseudo engine sound to be output from the output unit according to a working status of the electric working machine.

3. The electric working machine according to claim 2,
wherein the control unit is configured to adjust the pseudo engine sound to be output from the output unit according to at least any one of (i) a traveling speed of the electric working machine, (ii) a rotation speed of a traveling motor, (iii) a current value of the traveling motor, (iv) a rotation speed of the working unit, (v) a load of the working unit, (vi) a rotation speed of the motor and (vii) a current value of the motor.

4. The electric working machine according to claim 3,
wherein the working unit includes a cutter blade configured to be driven by the motor to cut grass, and
wherein the control unit is configured to adjust the pseudo engine sound to be output from the output unit according to a rotation speed of the cutter blade or a load of the cutter blade.

5. The electric working machine according to claim 1,
wherein the control unit is configured to cause a plurality of different types of the pseudo engine sound to be selectively output from the output unit.

6. The electric working machine according to claim 1, further comprising:
a vibration generator configured to generate a vibration in the electric working machine.

7. The electric working machine according to claim 6,
wherein the control unit is configured to control the vibration generator to generate a vibration in conjunction with a volume of the pseudo engine sound output form the output unit.

8. The electric working machine according to claim 1, further comprising:
an operator information obtaining unit configured to obtain a heart rate or a pulse of an operator of the electric working machine,
wherein the control unit is configured to adjust the pseudo engine sound according to the obtained heart rate or pulse.

9. The electric working machine according to claim 1,
wherein the output unit includes a speaker provided to the electric working machine such that an output sound is directed to an operator of the electric working machine.

10. The electric working machine according to claim 1,
wherein the output unit includes a terminal device which is detachably attached to the electric working machine or is held by an operator of the electric working machine, or an output device worn by an operator of the electric working machine, and
wherein the terminal device or the output device is configured to communicate with the control unit.

11. An information processing device used for an electric working machine configured to be driven by a motor to perform work, the information processing device comprising:
a communication unit configured to communicate with the electric working machine;
a working status obtaining unit configured to obtain a working status of the electric working machine via the communication unit; and
a control unit configured to cause a pseudo engine sound to be output from an output unit according to the obtained working status of the electric working machine.

12. A non-transitory storage medium storing a control program of an information processing device used for an electric working machine configured to be driven by a motor to perform work, the control program, when executed by a processor of the information processing device, causing the information processing device to operate as:
a working status obtaining unit configured to obtain a working status of the electric working machine; and
a control unit configured to cause a pseudo engine sound to be output from an output unit according to the obtained working status of the electric working machine.

13. The storage medium according to claim 12,
wherein the control unit is configured to adjust the pseudo engine sound to be output from the output unit according to at least any one of (i) a traveling speed of the electric working machine, (ii) a rotation speed of a traveling motor, (iii) a current value of the traveling motor, (iv) a rotation speed of a working unit of the electric working machine, (v) a load of the working unit, (vi) a rotation speed of the motor and (vii) a current value of the motor.

14. The storage medium according to claim 13,
wherein the electric working machine includes a cutter blade configured to be driven by the motor to cut grass, and
wherein the control unit is configured to adjust the pseudo engine sound to be output from the output unit according to a rotation speed of the cutter blade or a load of the cutter blade.

15. The storage medium according to claim 12,
wherein the control unit is configured to cause a plurality of different types of the pseudo engine sound to be selectively output from the output unit.

16. The storage medium according to claim 12,
wherein the control program, when executed by the processor, causes the information processing device to further operate as:
an operator information obtaining unit configured to obtain a heart rate or a pulse of an operator of the electric working machine, and
wherein the control unit is configured to adjust the pseudo engine sound according to the obtained heart rate or pulse.

17. The storage medium according to claim 12,
wherein the output unit includes a speaker provided to the information processing device.

18. The storage medium according to claim 12,
wherein the output unit includes an output device worn by an operator of the electric working machine, and
wherein the output device is configured to communicate with the control unit.
